(19) United States
(12) Patent Application Publication
(10) Pub. No.: US 2008/0142495 A1
(43) Pub. Date: Jun. 19, 2008

(54) Cosmetic Product Applicators, Particularly a Device for Spreading a Hair Remover Wax on the Skin Thereof

(76) Inventor: Christian Des Garets, Marolles en Hurepoix (FR)

Correspondence Address: NIXON & VANDERHYE, PC, 901 NORTH GLEBE ROAD, 11TH FLOOR, ARLINGTON, VA, 22203, US

(21) Appl. No.: 11/795,134

(22) PCT Filed: Jan. 10, 2006
(86) PCT No.: PCT/FR06/00046

§ 371 Date: Aug. 8, 2007

(30) Foreign Application Priority Data
Jan. 12, 2005 (FR) 0500310

(51) Int. Cl. H05B 1/00; A46B 11/08

(52) U.S. Cl. 219/228; 219/221; 401/1

(57) ABSTRACT

The invention relates to a device for spreading a hair remover wax on the skin, characterized in that it comprises: a first part (1) serving to house a heating device having means capable of heating a blade up to a controllable and constant temperature between 35° C. and 55° C., including the terminals, and; a second part (2) comprising said blade that is flat and made of a thermally conductive material and heated by the heating device.

The present invention relates in a general manner to cosmetic product applicators and particularly a device for spreading a hair-removal wax on the skin.

Hair removal, as it is currently practiced in specialist centers or at home, usually requires the application on the skin of a layer of variable thickness of hair-removal wax which coats the hair and remains sufficiently adhered to be able to impregnate a strip for the removal of the wax and the hairs, in the case of a wax designed for the use of strips, or which dries trapping the hair, in the case of the use of a stripless wax.

The application of the wax on the skin was until recent years carried out with the aid of a wooden, metal or plastic spatula being used to spread the wax on the skin according to the desired quantity. Spreader cartridges or rollers can still be used. These waxes are usually waxes that have to be heated or reheated. These waxes are used alone or with the aid of a nonwoven strip. The trend of the waxes wrongly called “cold” is to be usable at lower temperatures and therefore to have a lower softening point which tends to increase the fluidity of the wax.

The disadvantages of these waxes are that they require, in an obligatory manner, a heating to a temperature that is sometimes difficult for the skin to bear and, in the context of the use of the waxes called cold, require the application of a wax on the skin at ambient temperature, that is to say at a temperature lower than body temperature which has the effect of contracting the skin and therefore of making the hair follicle less accessible to the wax. In this precise case, pulling out the hairs becomes more painful and sometimes incomplete.

The invention proposes to solve these disadvantages by proposing a device for spreading a hair-removal wax on the skin that is practical, easy to use, economical and makes it possible to enhance the comfort of the user.

For this purpose, the device for spreading a hair-removal wax on the skin, according to the invention, comprises:
a first portion designed to contain a heating device comprising means capable of bringing a blade to an adjustable and constant temperature lying between 35° C. and 55° C., boundaries included, and
a second, flat portion forming said blade, made of a heat-conductible material and heated by said heating device.

Using on the skin a blade heated to a temperature close to body temperature is more pleasant than a wooden spatula. It relaxes the skin and slightly more fluidifies the wax which allows a better penetration of the latter. Pulling the hairs out is thereby more effective and less painful. Specifically, the longer the portion of the hair between the bulb and the surface coated in the wax, the greater the elasticity between the two fixed points consisting of the bulb and the wax and the more painful the pulling out of the hairs. By relaxing the skin thanks to the device according to the invention, the penetration of the wax is enhanced and the pulling out of the hair is less painful.

In addition, the use of a heated blade makes it possible to increase the fluidity of the wax and therefore to further enhance the penetration of the latter and the relaxation of the skin which accordingly increases the effectiveness of the pulling out and the comfort of the user.

In addition, certain “stripless” waxes very rapidly lose their tackiness. A heated blade makes it possible to no longer have this problem and to be better able to spread the wax on the portion from which hair is to be removed. This advantage also allows a substantial economy of wax.

Finally, the advantage that “cold” waxes confer, which is that they do not have to be reheated, nevertheless constitutes a major disadvantage because the skin does not like the cold. A heated blade therefore makes it possible to soften the operation at the same time as it allows a better distribution of the wax and therefore a substantial economy.

Preferably, said means capable of generating an adjustable and constant temperature of the device according to the invention comprise:
a PTC resistor,
a thermal fuse, and
an electric power supply.

More preferably, said electric power supply is chosen from batteries, accumulator batteries and accumulators, transformers and chargers.

More preferably still, said electric power supply is rechargeable or not, placed on said blade or connected thereto by a connector cable, or connected to the mains.

In a preferred embodiment of the device according to the invention, said first portion of said device also forms a holding handle in which said blade is placed fixedly, removably or interchangeably.

In another preferred embodiment of the device according to the invention, said first portion of said device is constituted in order to be adapted to the wax spreaders by screwing or clipping and comprises a passageway for said wax emerging through an orifice at said second portion, said second portion being very slightly flexible and placed fixedly, removably or interchangeably on said first portion.

Particularly, said blade of the device according to the invention is made of aluminum with a thickness lying between 0.5 mm and 3 mm, boundaries included, and said first portion comprises at least one housing for placing said PTC resistor and said thermal fuse.

Other features and advantages of the present invention will emerge from the description made below, with reference to the appended drawings which illustrate two exemplary embodiments that have no limiting character.

In the figures:

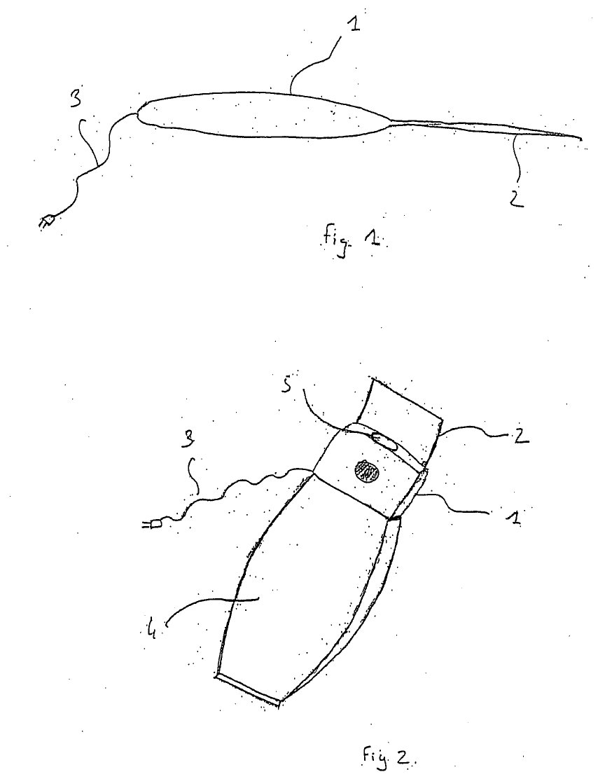

FIG. 1 is a view of a first embodiment of a hair-removal wax spreading device that is the subject of the invention.

FIG. 2 is a view of a second embodiment of the hair-removal wax spreading device that is the subject of the invention, placed on a conventional spreader.

With reference to FIG. 1, it can be seen that, in a first embodiment, the hair-removal wax spreading device represented that is the subject of the invention comprises a first portion 1 designed to contain a heating device comprising means capable of bringing a blade to an adjustable and constant temperature lying between 35° C. and 55° C., boundaries included, and a second, flat portion 2 forming said blade and heated by said heating device. Typically, said means capable of generating an adjustable and constant temperature comprise: a PTC resistor, a thermal fuse, and an electric power supply 3. In this particular embodiment, the electric power supply here is a connector cable 3 that must be connected to the mains.

Said first portion 1 of said device also forms a holding handle in which said blade is placed fixedly, removably or interchangeably. The value of having an interchangeable blade is of course hygiene which a hair-removing operation requires at the same time as a better adaptation to the portion from which the hair is to be removed. In the figure, the blade is permanently placed in said first portion 1.

Said second portion 2 here consists of a blade made of aluminum 2 mm thick and said PTC resistor and said thermal fuse are placed in a housing placed in the body of said first portion 1.

With reference now to FIG. 2, it can be seen that, in a second embodiment, the hair-removal wax spreading device represented that is the subject of the invention comprises a first portion 1 designed to contain a heating device comprising means capable of bringing a blade to an adjustable and constant temperature lying between 35° C. and 55° C., boundaries included, and a second, flat portion 2 forming a blade that is heated by said heating device. As for the embodiment previously described, said means capable of generating an adjustable and constant temperature comprise: a PTC resistor, a thermal fuse, and an electric power supply 3. In this particular embodiment, the electric power supply is here again a connector cable 3 that must be connected to the mains.

The first portion 1 of said device is constituted in order to be adapted to a spreader 4, typically here a 100 gram tube of wax, by screwing or clipping (here by screwing) and comprises a passageway for said wax emerging through an orifice 5 at said second portion 2, said second portion 2 being very slightly flexible and placed fixedly, removably or interchangeably on said first portion.

In this particular case, said blade is provided to be interchangeable for easily comprehensible reasons of hygiene.

Here also, said second portion 2 here consists of a blade made of aluminum 2 mm thick and said PTC resistor and said thermal fuse are placed in a housing placed in the body of said first portion 1.

1. A device for spreading a hair-removal wax on the skin, characterized in that it comprises:
a first portion (1) designed to contain a heating device comprising means capable of bringing a blade to an adjustable and constant temperature lying between 35° C. and 55° C., boundaries included, and
a second, flat portion (2) forming said blade, made of a heat-conductible material and heated by said heating device.

2. The device as claimed in claim 1, characterized in that said means capable of generating an adjustable and constant temperature comprise:
a PTC resistor,
a thermal fuse, and
an electric power supply (3).

3. The device as claimed in claim 2, characterized in that said electric power supply (3) is chosen from batteries, accumulator batteries and accumulators, transformers and chargers.

4. The device as claimed in claim 3, characterized in that said electric power supply (3) is rechargeable or not, placed on said blade or connected thereto by a connector cable, or connected to the mains.

5. The device as claimed in claim 1, characterized in that said first portion (1) of said device also forms a holding handle in which said blade is placed fixedly, removably or interchangeably.

6. The device as claimed in claim 1, characterized in that said first portion (1) of said device is constituted in order to be adapted to the wax spreaders (4) by screwing or clipping and comprises a passageway for said wax emerging through an orifice (5) at said second portion, said second portion (2) being very slightly flexible and placed fixedly, removably or interchangeably on said first portion.

7. The device as claimed in claim 1, characterized in that said blade is made of aluminum with a thickness lying between 0.5 mm and 3 mm, boundaries included, and in that said first portion (1) comprises at least one housing for placing said PTC resistor and said thermal fuse.
